(19) United States
(12) Patent Application Publication
(10) Pub. No.: US 2003/0015079 A1
(43) Pub. Date: Jan. 23, 2003

(54) Floating punch holder

(76) Inventor: John Talarico, Lasalle (CA)

Correspondence Address: Mila Shvartsman, 1495 Van Horne, P.O. Box 48652, Outremont, QC, H2V 4T9, CA

(21) Appl. No.: 09/908,692

(22) Filed: Jul. 20, 2001

(51) Int. Cl. B26F 1/14

(52) U.S. Cl. 83/698.91; 83/699.31; 83/685

(57) ABSTRACT

An improved floating punch-holder for a punching apparatus comprising an assembly of a chuck having an upper portion and a lower portion. The upper portion of the chuck is provided to be securely attached to the punching apparatus. The chuck is provided to hold a shank having an upper portion and a lower portion, the upper portion of the shank being held by the chuck and the lower portion of said shank is connected to a punch. The punch is adapted to cooperate with a die located below the punch and centered with the punch. A centering assembly is adapted to accommodate the upper portion of the shank and is provided to facilitate a precise alignment and centering of the punch with the die. Centering assembly is detachably mounted to the lower portion of the chuck and is adapted to retain the position of the shank centered, even when the shank is removed for servicing. A locking assembly is adapted to immobily lock the upper portion of the shank to the lower portion of the chuck.

This application is an improvement of the U.S. Pat. No. 5,992,285 to Joe Talarico.

The present invention relates to an apparatus for affixing a punch onto a machine such as a punch press, more particularly to a floating punch-holder, and provide the means to align the punch within the punch-holder with a corresponding hole in a die set on the bed or horn of the aforesaid machine to avoid the need of using a specialised machine or die set.

There is known U.S. Pat. No. 5,992,285 to Joe Talarico comprising a floating punch-holder provided with a chuck having within its lower portion an open-ended cavity to accommodate an upper portion of a shank connected to a punch. In this arrangement, the process of centering and alignment of the upper portion of the shank was performed by means of using sets of screws provided to adjust the shank's upper portion within the cavity by means of advance movement of said screws causing lateral movement of the upper portion of the shank.

Such an arrangement, even though it is very precise, necessitates all steps of alignment and centering of the shank each time the shank is removed for servicing.

The present improvement eliminates the described disadvantage and comprises an improved configuration of the centering assembly capable to keep the position of the shank “centered” even when the shank is removed for servicing.

### SUMMARY OF THE INVENTION

The primary objective of the present invention is to provide a floating punch-holder having a centereing means provided to facilitate a precise alignment and centering of the punch with the die in such a way that those centering means are adapted to retain the position of the shank centered even when the shank is removed for servicing.

The second objective of the present invention is to provide a floating punch holder of the type described above wherein the cenreting means comprises a locating ring and wherein the upper portion of the shank has a cylindrical configuration where an inner diameter of the locating ring fits precisely with a close tolerance within the upper portion of the shank.

The third objective of the present invention is to provide a floating punch holder of the type described above wherein the upper portion of the shank is locked to the lower portion of the chuck by a locking means comprising an outer clamp which is detachably mounted to the lower portion of the chuck by tightening means.

### BRIEF DESCRIPTION OF THE DRAWINGS

FIG. 1. shows a perspective view of the disassembled floating punch-holder according to the present invention.

FIG. 2 shows a side cross-section of the assembled punch-holder of FIG. 1.

FIG. 3 is a side cross-sectional view of a die assembly.

### DETAILED DESCRIPTION OF THE PRESENT INVENTION

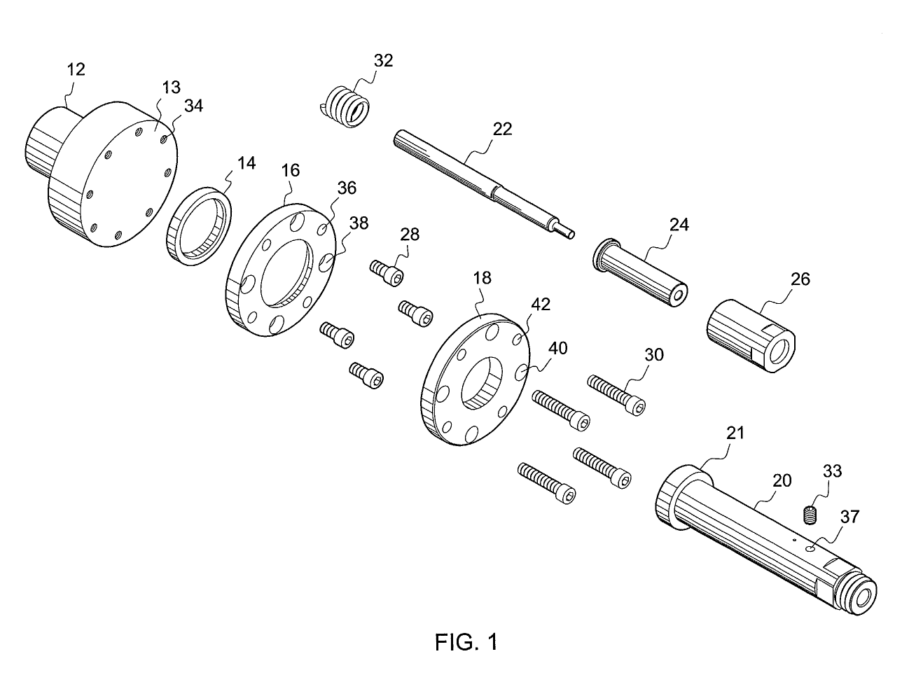

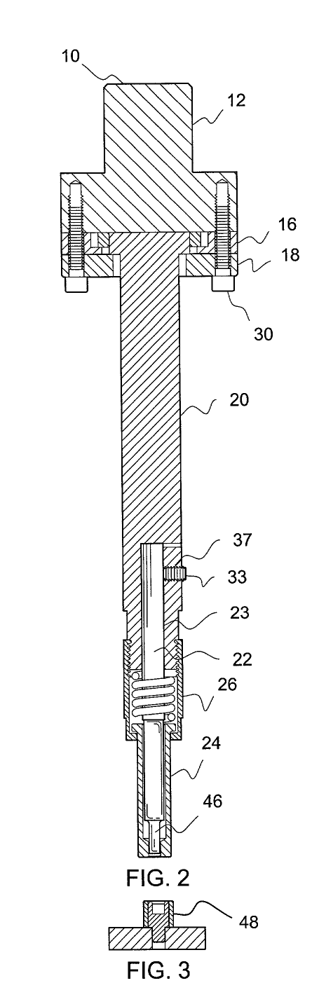

Referring now to drawings, FIGS. 1 and 2 show a floating punch-holder 10 comprising a chuck 12 having a shape of a stub provided for fastening into a ram (not shown). The lower portion 13 of the chuck 12 has a number of bore holes 34. Centering means or assembly comprises a locating ring 14 adapted to be held in place by means of an inner clamp 16 provided to be tightened to the chuck 12 by means of a set of screws 28. The locating ring 14 is adapted to move in lateral directions within the inner clamp 16 due to the fact that the outer diameter of the locating ring 14 is smaller than the inner diameter of the inner clamp 16. A shank 20 having an upper portion 21 of a cylindrical configuration is adapted to be accommodated within the locating ring 14. The inner diameter of the locating ring 14 has precise dimensions adapted to fit with close tolerance within the upper portion 21 of the shank 20, thus providing an accurate location and close tolerance of the upper portion of the shank in a slide-fit manner during centering and alignment. The shank 20 is held in place by means of an outer clamp 18 provided with bore holes 42. The outer clamp 18 is attached to the lower portion 13 of chuck 12 by means of a set of screws 30 and can be tightened into the corresponding bores 34 of chuck 12 completely independently from the centering assembly. This arrangement is achieved by means of using counter-bore holes 38 formed in the inner clamp 16 and allowing screws 30 holding outer clamp 18 to pass right through the inner clamp 16 to be attached directly to the chuck 12. This independency of attachment is a very important feature of the present invention. Due to the fact that the height or thickness of the upper portion of the shank 20 is greater than the height or thickness of the locating ring 14, outer clamp 18 will tightly hold only the upper portion 21 of the shank 20 without affecting the functioning of inner clamp 16 provided to hold the locating ring 14. Clearance holes 40 are formed on the outer clamp 18 to facilitate the access to screws 28 tightening the inner clamp 16.

The lower portion of the shank 20 is provided with a bore 23 for holding a punch 22 by means of a set screw 35 to be inserted within the corresponding bore hole 37 formed within the shank 20. The punch-holder further includes a spring holder 26, crown 24 and a spring 32. A tip 46 of the punch 22 is adapted to cooperate with a die 48 of FIG. 3 to perform a punching process.

In operation, the centering assembly comprising the locating ring 14 and inner clamp 16 is attached to the chuck 12 without complete tightening of screws 28. Further, shank 20 is placed within the locating ring 14 and attached to the chuck 12 by means of the outer clamp 18 without complete tightening of screws 30. In this case, screws 30 are inserted into the corresponding bore holes 34 formed in the lower portion 13 of the chuck 12 via counter-bore holes 38 of the inner clamp 16. During the alignment and centering, the upper portion 21 of the shank 20 is adjusted by lateral movement of the shank-ring assembly within the inner clamp 16. Once the assembly is aligned and tested on the machine, screws 28 holding the inner clamp 16 are completely tightened by means of accessing those screws through clearance holes 40 formed in the outer clamp 18 holding the upper portion 21 of the shank 20. As the result, the locating ring 14, which is held in place by means of the inner clamp 16, will retain the position of the shank “centered” even when the shank 20 is removed for servicing. For removing the shank for servicing, it is necessary to simply loosen screws 30 and to remove the outer clamp 18. During re-assembly, the shank 20 will be placed within the locating ring 14 exactly in the same position as it was when the centering was done. Such feature of the present invention permits easy removal of the shank and quick re-assembly without re-aligning of the punch assembly each time.

The fact that chuck 12 is the only holding device to hold both inner clamp 16 and outer clamp 18 makes such punch-holder assembly of the present invention very simple to handle.

Thus, it can be seen that the objects of the present invention have been satisfied by the structure presented hereinabove. While in accordance with the Patent Statutes, only the best mode and preferred embodiments of the present invention have been presented and described in detail, it is to be understood that the invention is not limited thereto or thereby. Accordingly, for an appreciation of the true scope and breadth of the invention, references should be made to the following claims.

1. Floating punch-holder for a punching apparatus comprising an assembly of:
a chuck having an upper portion and a lower portion, the upper portion of said chuck is provided to be securely attached to the punching apparatus, said chuck is provided to hold
a shank having an upper portion and a lower portion, the upper portion of said shank being held by said chuck and the lower portion of said shank is connected to
a punch, said punch is adapted to cooperate with
a die located below the punch and centred with said punch;
a centring means adapted to accommodate the upper portion of said shank, said centring means are provided to facilitate a precise alignment and centring of said punch with said die;
wherein said centring means are detachably mounted to the lower portion of said chuck, and wherein said centring means are adapted to retain the position of said shank centred even when said shank is removed for servicing;
a locking means adapted to immobily lock the upper portion of said shank to the lower portion of said chuck.

2. Floating punch-holder according to claim 1, wherein said centring means are adapted to accommodate the upper portion of said shank in a slide-fit manner.

3. Floating punch-holder according to claim 2, wherein said centring means comprises a locating ring, and wherein the upper portion of said shank having a cylindrical configurations, wherein an inner diameter of said locating ring fits precisely with a close tolerance within the upper portion of said shank.

4. Floating punch-holder according to claim 3, wherein said locating ring is detachably mounted to the lower portion of said chuck by an inner clamp, wherein said locating ring is adapted to move within said inner clamp in lateral directions necessary for precise alignment and centring of said punch with said die.

5. Floating punch-holder according to claim 4, wherein said inner clamp is detachably mounted to lower portion of said chuck by tightening means.

6. Floating punch-holder according to claim 4, wherein said locking means comprises an outer clamp, said outer clamp is detachably mounted to the lower portion of said chuck by tightening means.

7. floating punch-holder according to claim 6, wherein said inner clamp is provided with a number of counter-bore holes formed in said inner clamp, wherein said counter-bore holes allow said outer clamp to be locked directly to the lower portion of said chuck.
